(19) United States
(12) Patent Application Publication
(10) Pub. No.: US 2006/0028594 A1
(43) Pub. Date: Feb. 9, 2006

(54) DISPLAY MODULE HOUSING

(76) Inventor: Ming Chuan Chou, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,110

(22) Filed: Dec. 16, 2004

(30) Foreign Application Priority Data
Aug. 3, 2004 (TW) 093123271

(51) Int. Cl. G02F 1/1333

(52) U.S. Cl. 349/58

(57) ABSTRACT

A display module housing for fixing a display panel comprises a frame structure, at least a fixing mechanism, and at least a flexible fastening device disposed on the topside of the sidewall of the frame structure. When the display panel is positioned in the frame structure, the fixing mechanism and the flexible fastening device clip the display panel so that the display panel is fixed in the display module housing.

### BACKGROUND OF INVENTION

1. Field of the Invention

The present invention provides a display module housing, more specifically, a display module housing with specific fastening devices.

2. Description of the Prior Art

With the rapid development of technology, various kinds of intelligent information products are available to people living in modern societies. For example, flat display modules, such as liquid crystal display modules, etc., have played quite an important role in information products. Since the flat display module has the characteristics of a light and portable configuration, low power consumption, no radiation pollution, and so on, it has been widely applied to portable information products, such as notebooks, personal digital assistants (PDAs), and cellular phones, etc. There is even a trend of gradually replacing the CRT monitor of conventional personal computers and CRT TVs with the flat display module.

Please refer to FIG. 1. FIG. 1 is a cross-sectional view of a display module 100 according to the prior art. As shown in FIG. 1, the display module 100 comprises a flat display panel 102 and a display module housing 104. If the display panel 102 is a liquid crystal display panel, there is usually a back light module (not shown), comprising back light module elements such as a light guide plate and optical films, etc., disposed there beneath. Generally, in order to immobilize the flat display panel 102 into the display module housing 104, fixing glue 106 is placed between the display module housing 104 and the flat display panel 102 to adhere the flat display panel 102 to the display module housing 104.

The conventional fixing glue 106, however, is double tape formed with acrylic. Therefore, in response to the change of temperature and humidity, and as the fixing glue 106 gets older, the stickiness of the fixing glue 106 is gradually reduced. Therefore, the flat display panel 102 may not be effectively fastened, and the reliability of the display module 100 may thus be reduced. Even when performing a reliability test or upon an inappropriate impact by an external force, it is possible that the flat display panel 102 may warp upwards and separate from the display module housing 104.

### SUMMARY OF INVENTION

It is therefore a primary objective of the present invention to provide a display module housing having a particular fastening device, so that the function of fixing glue for fastening the display panel used in the prior art can be enhanced or substituted, and the inability to fasten the display panel due to the reduction in stickiness of the fixing glue can be solved.

According to the claimed invention, a display module housing is disclosed to immobilize a display panel. The display module housing of the present invention comprises a frame structure, at least a fixing mechanism, and at least a flexible fastening device. The frame structure is provided with a holding space for accommodating the display panel. The fixing mechanism is disposed on the topside of the sidewall of the frame structure, and protruding to the surface of the sidewall of the frame structure, while the flexible fastening device is disposed on the topside of the sidewall of the frame structure as well. When the display panel is positioned in the holding space of the frame structure, the fixing mechanism and the flexible fastening device may clip and immobilize the display panel so that the display panel is immobilized in the display module housing.

Since the display module housing of the present invention is provided with a fixing mechanism and a flexible fastening device, the display panel may be clipped and immobilized in the display module housing, and no additional fixing glue is required to be adhered thereto. Thus, the prior art problem of the reduced stickiness of the fixing glue, which causes the display panel to warp upwards and separate from the housing, can be solved to make the display module housing more shock-resistant.

### BRIEF DESCRIPTION OF DRAWINGS

FIG. 1 is a cross-sectional view of a conventional display module.

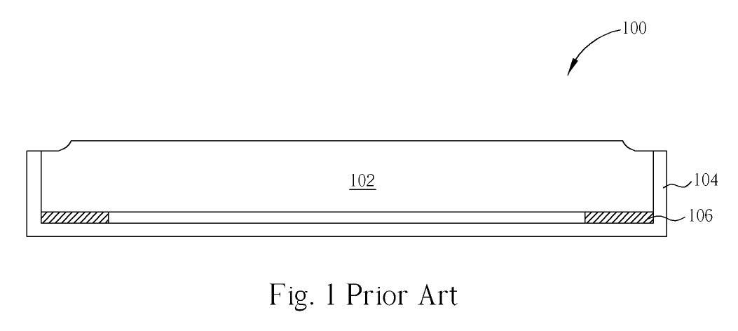

FIG. 2 is a schematic diagram of the display module housing of the present invention.

FIG. 3 is a cross-sectional view of a display panel and the display module housing shown in FIG. 2.

FIG. 4 is a schematic diagram showing the display module housing of a second embodiment of the present invention.

FIG. 5 is a schematic diagram showing the display module housing of a third embodiment of the present invention.

FIG. 6 is a cross-sectional view of the display module housing accommodating a display panel shown in FIG. 5.

### DETAILED DESCRIPTION

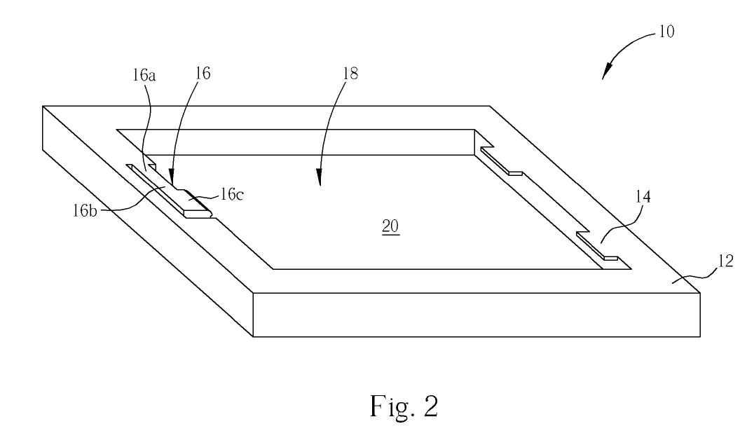

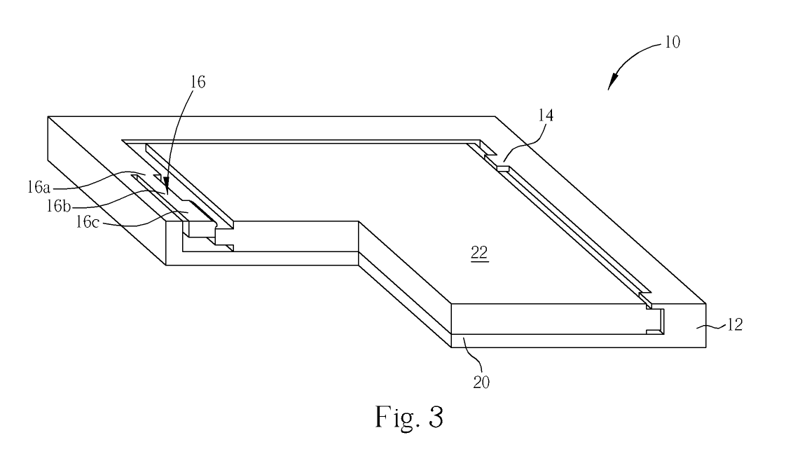

Please refer to FIG. 2 and FIG. 3. FIG. 2 is a schematic diagram of a display module housing 10 of the present invention, and FIG. 3 is a cross-sectional view of a display panel 22 and the display module housing 10 shown in FIG. 2. The display module housing 10 is used to immobilize the display panel 22, and comprises a frame structure 12, two fixing mechanisms 14, and a flexible fastening device 16. The frame structure 12 is a rectangular frame structure providing a holding space 18 for accommodating the display panel 22. The fixing mechanism 14 is a clasping mechanism, such as a rectangular hook, disposed on the topside of the sidewall of the frame structure 12 and protruding to the surface of the sidewall of the frame structure 12 to clip and immobilize the edge of the display panel 22 into the holding space 18. Each of the fixing mechanisms 14 shown in FIG. 2 is (but is not limited to being) a rectangular clasping mechanism, and it can also be a strip clasping mechanism. On the other hand, the two fixing mechanisms 14 may be substituted by three or more clasping mechanisms with smaller shapes, which are disposed equally on the topside of the sidewall of the frame structure 12.

The flexible fastening device 16, which is disposed on the topside of the sidewall of the frame structure 12 and located on the sidewall of the frame structure 12 opposite to the fixing mechanisms 14, is used to push and make the display panel 22 be in contact with the sidewall of the frame structure 12 where the fixing mechanisms 14 are located, and make the fixing mechanisms 14 clip and fix the display panel 22 effectively. In this embodiment of the present invention, the flexible fastening mechanism 16 comprises a flexible pivot 16a, a tension arm 16b, and a pushing mechanism 16c. The tension arm 16b is a strip mechanism with a width slightly smaller than that of the frame structure 12, the flexible pivot 16a is the intersection of the tension arm 16b and the frame structure 12, and the pushing mechanism 16c is disposed at the end of the tension arm 16b, providing a block structure that protrudes to the tension arm 16b. Since the flexible fastening device 16 is formed from a tough plastic material, the pushing mechanism 16c disposed at the end of the tension arm 16b may be moved inwards or outwards in the presence of the flexible pivot 16a as a moving support by means of the design of the flexible pivot 16a and the tension arm 16b.

When the display panel 22 is configured within the display module housing 10, the tension arm 16b may urge the pushing mechanism 16c to move outwards, making the display panel 22 be arranged inside the holding space 18. When the display panel 22 is completely disposed, the tension arm 16b as well as the pushing mechanism 16c may bounce inwards to push the display panel 22 and immobilize the display panel 22 together with the fixing mechanisms 14. It should be noted that, a portion of the surface of the pushing mechanism 16c may cover the surface of the edge of the display panel 22 to ensure that the display panel 22 will not separate from the display module housing 10 due to an impact or shaking. Furthermore, the flexible fastening device 16 is not limited to the shape disclosed in FIG. 2, and may instead be other design structures that are flexible and integrated with the frame structure 12. In addition, the flexible fastening device 16 may be a leaf spring or a spring as well.

In this embodiment of the present invention, the display module housing 10 further comprises a bottom plate 20 connected to the lower end of the sidewall of the frame structure 12 to form the holding space 18 for accommodating the display panel 22. Furthermore, the display panel 22 shown in FIG. 3 is an organic light emitting diode (OLED) display panel. The display panel 22, however, may be a liquid crystal display panel or other flat display panels.

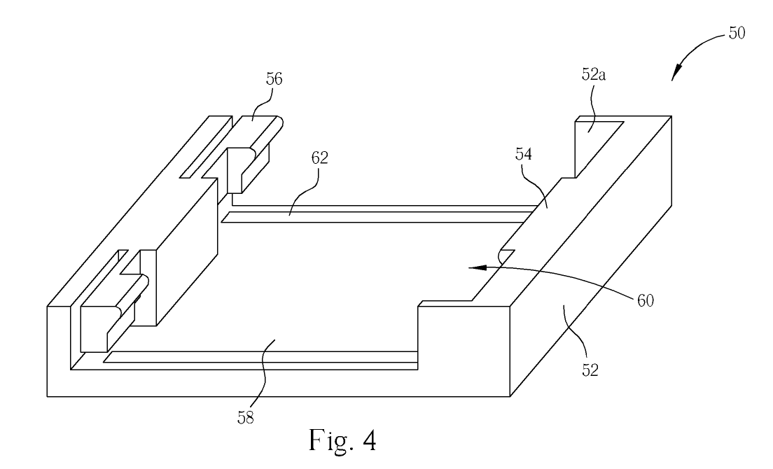

Please refer to FIG. 4. FIG. 4 is a schematic diagram of a display module housing 50 of the second embodiment according to the present invention. The display module housing 50 comprises a frame structure 52, a fixing mechanism 54, two flexible fastening devices 56, and a bottom plate 58. As shown in FIG. 4, the frame structure 52 is formed in conjunction with the bottom plate 58 to form a holding space 60 which can accommodate a display panel. In addition, the frame structure 52 has discontinuous sidewalls. As shown in FIG. 4, on the front and back side of the frame structure 52 possess only a part of the sidewall 52a, which provides the function of preventing the display panel placed in the holding space 60 from sliding forwards and backwards. The fixing mechanism 54 has a strip clasping structure protruding to the topside surface of the sidewall 52a of the frame structure 52, and works in association with the two flexible fastening devices 56 to clip and immobilize the surface of the display panel. Furthermore, in order to enhance the performance of immobilizing the display panel in the display module housing 50, the bottom plate 58 may be optionally coated with fixing glue 62.

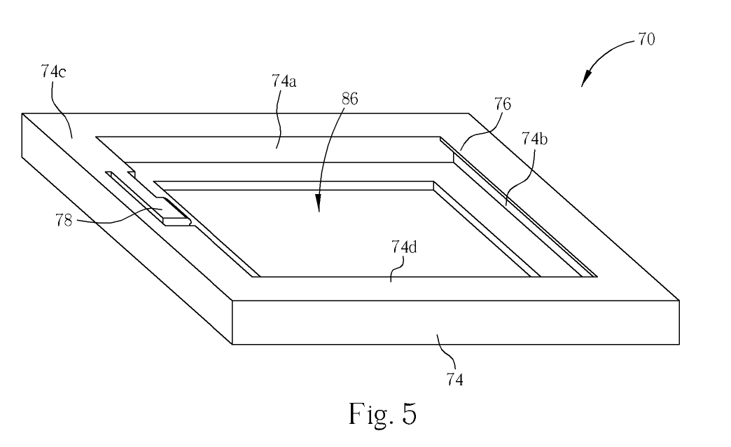

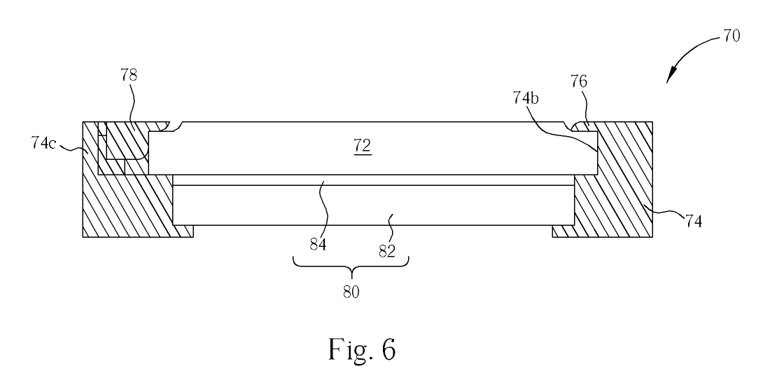

Please refer to FIG. 5 and FIG. 6. FIG. 5 is a schematic diagram of a display module housing 70 of a third embodiment according to the present invention, while FIG. 6 is a cross-sectional view of the display module housing 70 accommodating a display panel 72 shown in FIG. 5. The display module housing 70 comprises a frame structure 74, a fixing mechanism 76, and a flexible fastening device 78. The frame structure 74 has four sidewalls 74a, 74b, 74c, and 74d, warping together to form a rectangular framework, and thus forming a holding space 86 for accommodating the display panel 72, wherein the display panel 72 is a liquid crystal display panel. The fixing mechanism 76 is a strip cover plate, protruding to the sidewall 74b of the frame structure 74, and is formed in conjunction with the sidewalls 74a and 74d of the frame structure 74. As shown in FIG. 6, the fixing mechanism 76 covers the edge surface in one side of the display panel 72 to immobilize the display panel 72 to the holding space 86.

It should be noted that, the display module housing 70 of the present embodiment does not comprise a bottom plate, and the display module housing 70, therefore, is a hollow framework. On the other hand, since the display panel 72 is a liquid crystal display panel generally requiring a back light module, the holding space 86 is designed to accommodate the display panel 72 and a back light module 80 at the same time. As shown in FIG. 6, the back light module 80 comprises a light guide plate 82 and at least an optical film 84. In the meanwhile, fixing glue, such as a double tape, may be optionally disposed between the display module housing 70 and the display panel 72 to enhance the immobilization of the display panel 72.

Since a conventional display module housing is made from metal or plastic material with plasticity or tenacity, the display module housing providing a flexible fastening device and a fixing mechanism of the present invention may be directly fabricated by means of a monolithic forming technique. Therefore, the display panel can be effectively immobilized to the display module housing by the above-mentioned materials, which provide the necessary elasticity without any additional manufacturing processes, costs, and modifications to the size specification of original display panels.

In comparison to the prior art, the display module housing of the present invention provides a special design of a fixing mechanism and a flexible fastening device, so that the flexible fastening device can flexibly move for disposing the display panel in the display module housing easily. It may also utilize the moving function of the flexible fastening device to remove the display panel easily, and thus it is advantageous for disassembling and maintaining the display module. Furthermore, if fixing glue is used, the design of clipping and immobilizing the display panel to the holding space by means of the fixing mechanism and flexible fastening device solves the prior art problem in which the display panel may easily separate from the display module caused by the adhesion loss of the fixing glue. As a result, even after the loss in adhesion of the fixing glue, the fixing mechanism and the flexible fastening device may fasten the display panel firmly to the display module housing. In addition, the display module housing of the present invention may be applied to various display devices, and the reliability of the display devices and the convenience of assembly may be also improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A display module housing for immobilizing a display panel, the display module housing comprising:
a frame structure, the frame structure providing a holding space for accommodating the display panel;
at least a fixing mechanism disposed on a topside of a sidewall of the frame structure, and protruding to the surface of the sidewall of the frame structure; and
at least a flexible fastening device disposed on the topside of the sidewall of the frame structure;
wherein when the display panel is positioned in the holding space of the frame structure, the fixing mechanism and the flexible fastening device clip the display panel so that the display panel is fixed in the display module housing.

2. The display module housing of claim 1, wherein the fixing mechanism is a clasping mechanism.

3. The display module housing of claim 2, wherein the clasping mechanism is a rectangular hook.

4. The display module housing of claim 1, wherein the flexible fastening device comprises:
a flexible pivot jointed to the topside of the sidewall; and
a tension arm extending from the flexible pivot and protruding to the sidewall.

5. The display module housing of claim 4, wherein the flexible fastening device further comprises a pushing mechanism.

6. The display module housing of claim 1, wherein the display panel is a liquid crystal display panel.

7. The display module housing of claim 6, wherein the holding space of the display module housing further accommodates a back light module.

8. The display module housing of claim 7, wherein the back light module comprises a light guide plate.

9. The display module housing of claim 8, wherein the back light module comprises an optical film.

10. The display module housing of claim 1, wherein the display panel is an organic light emitted diode display panel.

11. The display module housing of claim 1, wherein the frame structure is a rectangular frame structure.

12. The display module housing of claim 1, wherein fixing glue for use in fastening the display panel is disposed inside the holding space.

13. The display module housing of claim 1, wherein the display module housing further comprises a bottom plate connected to the frame structure, the bottom plate in combination with the frame structure forming the holding space.
